(19) United States
(12) Patent Application Publication
(10) Pub. No.: US 2008/0100940 A1
(43) Pub. Date: May 1, 2008

(54) FILTER SET AND A COLOR WHEEL USING THE SAME

(75) Inventors: Ying-Ling Tsai, Hsinchu (TW); Hsin-Tai Wu, Hsinchu (TW); Fu-Ming Chuang, Hsinchu (TW); Hsien-Chang Chen, Hsinchu (TW)

Correspondence Address: MARSH, FISCHMANN & BREYFOGLE LLP, 3151 SOUTH VAUGHN WAY, SUITE 411, AURORA, CO, 80014, US

(73) Assignee: YOUNG OPTICS INC., Hsinchu (TW)

(21) Appl. No.: 11/845,434

(22) Filed: Aug. 27, 2007

(30) Foreign Application Priority Data
Nov. 1, 2006 (TW) 095140385

(51) Int. Cl. G02B 5/22

(52) U.S. Cl. 359/889

(57) ABSTRACT

A color wheel includes a motor having a rotary shaft, and a filter set sleeved on the rotary shaft. The filter set including a filter plate having a central axis and upper and lower surfaces, and a first and a second packing disposed concentrically and respectively on the upper and lower surfaces of the filter plate. The first packing has a first notch formed therein. The second packing has a second notch formed in an upper surface thereof. An adhering unit is provided in the first and second notches to fix respectively the first and second packing to the upper and lower surfaces of the filter plate.

### CROSS-REFERENCE TO RELATED APPLICATION

This application claims priority of Taiwanese Application No. 095140385, filed on Nov. 1, 2006.

### BACKGROUND OF THE INVENTION

1. Field of the Invention

The invention relates to a color wheel, more particularly to a filter set and a color wheel using the same.

2. Description of the Related Art

Referring to FIGS. 1 and 2, a conventional color wheel 1 includes a motor 11, and a filter plate 12 and a packing ring 13 both connected to the motor 11. The filter plate 12 and the packing ring 13 are connected to the motor 11 by first smearing an epoxy layer to a surface 111 and a rotary shaft 112 of the motor 11, after which a through hole 121 of the filter plate 12 is passed over the rotary shaft 112 to adhere the filter plate 12 on the surface 111 of the motor 11. Subsequently, the packing ring 13 is sleeved on and is adhered to the rotary shaft 112. Finally, the entire color wheel 1 is placed in an oven to cure the epoxy layer, so that the filter plate 12 and the packing ring 13 are adhered fixedly to the motor 11.

Since in the aforementioned assembly method, the motor 11 is also placed in the oven, but the motor 11 cannot endure a high baking temperature, therefore a low heat-resistant adhesive, such as epoxy, must be selected and used. However, if such a low heat-resistant adhesive is used, when the motor 11 rotates for a long period of time, the adhesive layer between the filter plate 12 and the motor 11 easily undergoes a chemical change, such as carbonization, as a result of the high temperature generated during long rotation of the motor 11. Thus, the filter plate 12 becomes detached from the motor 11, and individual sections of the filter plate 12 scatter away from the motor 11 due to centrifugal force when the motor 11 rotates at high speed.

To prevent having to include the motor 11 in a high temperature baking process, U.S. Pat. Nos. 6,970,309, 5,868,482, and 6,024,453, and U.S. Publication No. 2006/0028746 each discloses a method that includes two baking processes. Firstly, a filter plate and a packing ring are adhered to each other, after which they are sent to a first baking process to form a filter set. The filter set is then adhered to a motor, and is sent, together with the motor, to a second baking process. As such, a high heat-resistant adhesive may be selected and used, thereby resolving the problem of detachment and scattering of the filter plate.

However, in U.S. Pat. No. 6,970,309 and the U.S. Publication No. 2006/0028746, each disclosed color wheel has a filter that needs to undergo a drilling process so as to form a groove or a through hole for disposal of an adhesive layer therein so that the filter and a packing ring can be adhered to each other. The filter, which is made of glass, may easily crack or fracture due to vibrations generated during the drilling process. Further, the strength of the filter after drilling is adversely affected, so that the filter is easily broken.

In U.S. Pat. Nos. 5,868,482 and 6,024,453, each disclosed color wheel is made by first smearing an adhesive layer, such as epoxy, on only one surface of a packing ring, after which the filter is adhered to the packing ring. Since the filter plate has only one surface adhered to the packing ring, the adhesion of the filter to the packing ring is not strong, so that scattering of the color filter plate as described above may occur easily. Further, since the epoxy is a hard adhesive, the filter plate may crack easily.

### SUMMARY OF THE INVENTION

Therefore, one object of the present invention is to provide a filter set that may use a highly heat-resistant adhesive as an adhering unit and that requires no drilling process for filter plates of the filter set.

Another object of the present invention is to provide a color wheel having a filter set that is not easily broken and scattered.

According to one aspect of this invention, a filter set comprises a filter plate, a first packing ring, a second packing ring, and an adhering unit. The filter plate has a central axis, an upper surface, and a lower surface opposite to the upper surface. The first packing ring is disposed concentrically on the upper surface of the filter plate, and has a lower surface facing the filter plate and a first notch formed thereon. The second packing ring is disposed concentrically below the lower surface of the filter plate, and has an upper surface facing the filter plate, and the upper surface has a second notch formed thereon. The adhering unit is provided in the first and second notches for fixing the first and second packing rings respectively to the upper and lower surfaces of the filter plate.

According to another aspect of this invention, a color wheel comprises a motor having a rotary shaft, and a filter set sleeved on the rotary shaft and including a filter plate, a first packing ring, a second packing ring, and an adhering unit. The filter plate has a central axis, an upper surface, and a lower surface opposite to the upper surface. The first packing ring is disposed concentrically on the upper surface of the color filter plate, and has a lower surface facing the color filter plate and a first notch formed thereon. The second packing ring is disposed concentrically below the lower surface of the filter plate, and has an upper surface facing the filter plate, the upper surface has a second notch formed thereon. The adhering unit is provided in the first and second notches for fixing the first and second packing rings respectively to the upper and lower surfaces of the filter plate.

In this invention, the filter plate and the first and second packing rings are firstly formed into a filter set, after which they are assembled on the motor. Thus, an adhering unit having a high heat-resistance may be selected and used for adhering the color filter plate and the first and second packing rings, after which the color filter set is sent for high temperature baking at approximately 200° C. Hence, the adhering unit of the filter set is prevented from undergoing carbonization due to high temperatures generated by long operation of the motor, and an assembly time of the filter set and the motor is shortened. Further, the adhering unit of the filter set forms a substantially C-shaped structure to clamp tightly the filter plate, and permits the filter plate to adhere securely between the first and second packing rings.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional color wheel;

FIG. 2 is an assembled perspective view of the conventional color wheel of FIG. 1;

FIG. 3 is an exploded perspective view of a color wheel according to a first preferred embodiment of the present invention;

FIG. 4 is an assembled sectional view of the first preferred embodiment;

FIG. 5 is an exploded perspective view of a color wheel according to a second preferred embodiment of the present invention;

FIG. 6 is an assembled sectional view of the second preferred embodiment;

FIG. 7 is an exploded perspective view of a color wheel according to a third preferred embodiment of the present invention; and

FIG. 8 is an assembled sectional view of the third preferred embodiment.

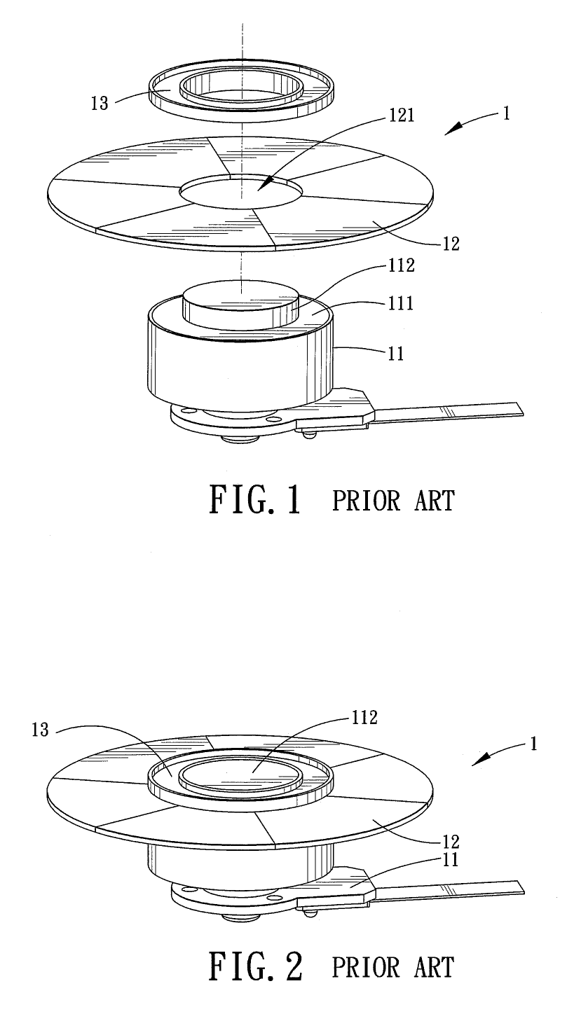

### DETAILED DESCRIPTION OF THE PREFERRED EMBODIMENTS

Before the present invention is described in greater detail, it should be noted that like elements are denoted by the same reference numerals throughout the disclosure. In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

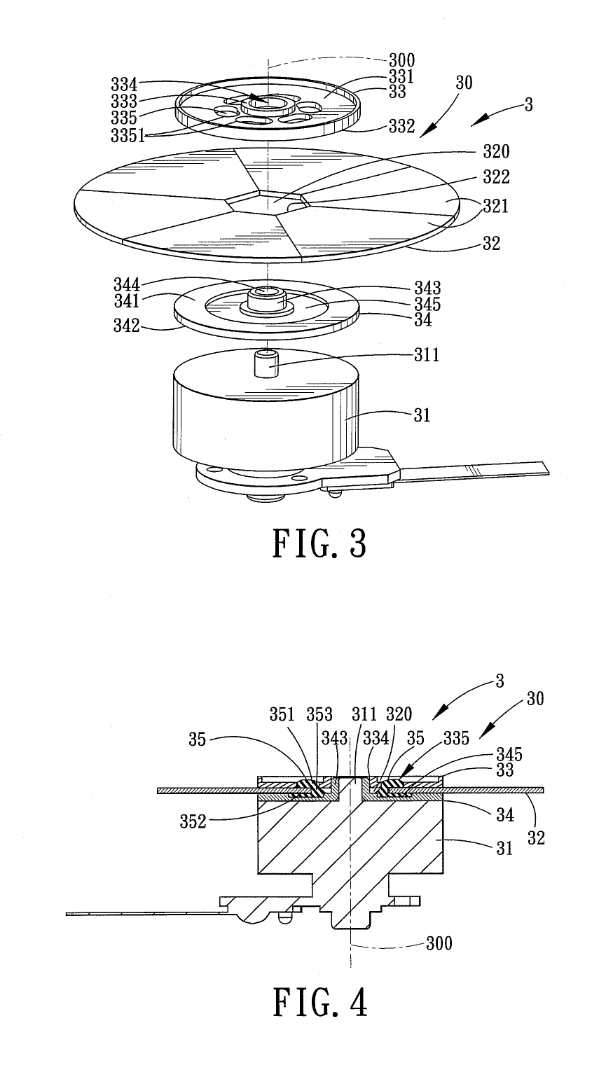

Referring to FIGS. 3 and 4, a color wheel 3 according to a first preferred embodiment of the present invention is shown to comprise a motor 31 and a filter set 30.

The motor 31 has a rotary shaft 311.

The color filter set 30 is sleeved on the rotary shaft 311 of the motor 31. When the motor 31 operates, the color filter set 30 rotates along with the rotary shaft 311. The color filter set 30 includes a filter plate 32, a first packing ring 33, a second packing ring 34, and an adhering unit 35. The filter plate 32 includes a plurality of truncated sector-shaped filter plates 321, an axial line 300 passing through the center of the filter plate 32, an upper surface, and a lower surface opposite to the upper surface. The lower surface of the filter plate 32 faces the motor 31. The sector-shaped filter plates 321 are interconnected so as to form a disc-like configuration having a central hole 320. The sector-shaped filter plates 321 may be made of glass. In this embodiment, six sector-shaped filter plates 321 are used and are interconnected to form the filter plate 32. Each sector-shaped filter plate 321 has an inner peripheral portion 322. The inner peripheral portion 322 of each sector-shaped filter plate 321 is a straight line, and the inner peripheral portions 322 of the sector-shaped filter plates 321 are interconnected to form a hexagonal central hole 320.

The first packing ring 33 is circular, and has a lower surface 332 facing the filter plate 32, and an upper surface 331 opposite to the lower surface 332. The upper surface 331 of the first packing ring 33 has a first hub 333 projecting from the center thereof. The first hub 333 defines a first central hole 334 extending therethrough. The first packing ring 33 further includes a first notch 335 formed in the first packing ring 33. In this embodiment, the first notch 335 includes a plurality of angularly spaced-apart through holes 3351 extending through the upper and lower surfaces 331, 332 of the first packing ring 33 and surrounding the first central hole 334.

The second packing ring 34 is circular, and has an upper surface 341 facing the filter plate 32, and a lower surface 342 opposite to the upper surface 341. The upper surface 341 of the second packing ring 34 has a second hub 343 projecting from the center thereof. The second hub 343 defines a second central hole 344 extending therethrough. The second packing ring 34 further has a second notch 345 formed on the upper surface 341 thereof. In this embodiment, the second notch 345 is an annular groove that surrounds the second central hole 344.

The inner peripheral portions 322 of the sector-shaped color filter plates 321 cover the first and second notches 335, 345 partially, so that the central hole 320 and the first and second notches 335, 345 are in spatial communication with each other. In this embodiment, the central hole 320 of the filter plate 32 is hexagonal as described above, and thus has six interior angles. Preferably, the first notch 335 of the first packing ring 33 has six through holes 3351. Hence, when the first and second packing rings 33, 34 are connected to the color filter plate 32, the first packing ring 33 can communicate spatially with the second notch 345 of the second packing ring 34 through the six through holes 3351 that communicate with the six interior angles of the central hole 320. The central hole 320 of the color filter plate 32 may also be circular, as long as the inner peripheral portions 322 of the sector-shaped filter plates 321 cover the first and second notches 335, 345 partially.

The adhering unit 35 is disposed in the central hole 320, the first notch 335, and the second notch 345. The first and second packing rings 33, 34 are adhered fixedly, concentrically, and respectively to the upper and lower surfaces of the color filter plate 32 through the adhering unit 35. The adhering unit 35 may be an adhesive, and includes interconnected first, second, and third portions 351, 352, 353. The first portion 351 is disposed in the first notch 335 of the first packing ring 33 so as to adhere the first packing ring 33 to the upper surface of the filter plate 32. The second portion 352 is disposed in the second notch 345 of the second packing ring 34 so as to adhere the second packing ring 34 to the lower surface of the filter plate 32. The third portion 353 is disposed in the central hole 320 of the filter plate 32 so as to interconnect the first and second portions 351, 352. The cross section of the first, second and third portions 351, 352, 353 is substantially C-shaped.

In this embodiment, the interconnection of the first and second packing rings 33, 34 and the filter plate 32 is accomplished by first filling the second notch 345 in the upper surface 341 of the second packing ring 34 with the adhering unit 35, which is a highly heat-resistant material, such as silica gel in this embodiment, after which the filter plate 32 is sleeved on the second hub 343 of the second packing ring 34 via the central hole 320. The filter plate 32 is adhered to the upper surface 341 of the second packing ring 34 through the adhering unit 35. The first packing ring 33 is then sleeved on the second hub 343 of the second packing ring 34 via the first central hole 334 in the first hub 333, and is disposed on the upper surface of the filterplate 32, so that the filterplate 32 is clamped between the lower surface 332 of the first packing ring 33 and the upper surface 341 of the second packing ring 34. Subsequently, the adhering unit 35 is introduced into the first notch 335 so as to adhere the first packing ring 33 to the filter plate 32. The entire filter set 30 is compressed by a tool, and is placed in an oven for high temperature baking at approximately 200° C. so as to cure the adhering unit 35. The entire filter set 30 is then sleeved on the rotary shaft 311 of the motor 31 with the lower surface 342 of the second packing ring 34 facing the motor 31.

In this embodiment, the filter set 30 is press-fitted onto the rotary shaft 311 of the motor 31. Hence, a diameter of the second central hole 344 of the second packing ring 34 is a little smaller than an outer diameter of the rotary shaft 311 of the motor 31. However, in actual practice, the second central hole 344 of the second packing ring 34 may be provided with an internal thread, and the rotary shaft 311 of the motor 31 may be provided with an external thread to engage the internal thread. As such, the filter set 30 and the motor 31 are engaged to each other. Further, an adhesive layer may be provided between the rotary shaft 311 of the motor 31 and the second central hole 344 of the second packing 34, so that the filter set 30 is adhered fixedly to the motor 31. Thereafter, the filter set 30 and the motor 31 are sent to an oven to bake at a low temperature of about 85° C. so as to cure the adhesive layer and so as to fix the filter set 30 to the motor 31. The adhesive layer may be a low heat-resistant adhesive, such as epoxy or an ultraviolet curing adhesive. Hence, the motor 31 is not subjected to a high temperature baking process.

Therefore, in this embodiment, aside from surface adhesion of the adhering unit 35 to fix the filter plate 32, the cured adhering unit 35 with C-shaped cross section also permits strong fixing of the filter plate 32, thereby preventing the occurrence of a scattering phenomenon of the filter plate 32. This is enhanced by the fact that through the first, second and third portions 351, 352, 353 of the adhering unit 35, the upper and lower surfaces and the inner peripheral portions 322 of the color filter plate 32 can adhere strongly to the first and second packing rings 33, 34. Further, with the six interior angles of the sector-shaped filter plates 321 which form the hexagonal central hole 320 of the filter plate 32, there is no need to drill holes in the filter plate 32, thereby preventing the occurrence of cracks or fractures in, or breakage of, the sector-shaped filter plates 321 due to a drilling process. Additionally, since the silica gel used for the adhering unit 35 in this embodiment is a soft adhesive, breakage of the filter plate 32 is not likely to occur.

In this embodiment, the first and second packing rings 33, 34 and the filter plate 32 are interconnected firstly to form the filter set 30, after which the filter set 30 is sent to a high-temperature oven. Thereafter, the filter set 30 is connected to the motor 31. Hence, the adhering unit 35 used for interconnecting the first and second packing rings 33, 34 and the filter plate 32 can be an adhesive with a high heat-resistance, so that carbonization of the adhering unit 35 due to subjection to high temperatures resulting from long rotational operation of the motor 31 and scattering of the filter plate 32 do not occur. Furthermore, since the first and second packing rings 33, 34 are provided respectively with the first and second notches 335, 345 to receive the adhering unit 35 therein, when the first and second packing rings 33, 34 and the filter plate 32 are interconnected, the adhering units 35 in the first and second notches 335, 345 can be interconnected via the central hole 320 in the filter set 30, so that the adhering unit 35 has a substantially C-shaped cross section that produces a clamping effect on the filter plate 32, thereby preventing a scattering phenomenon of the color filter plate 32.

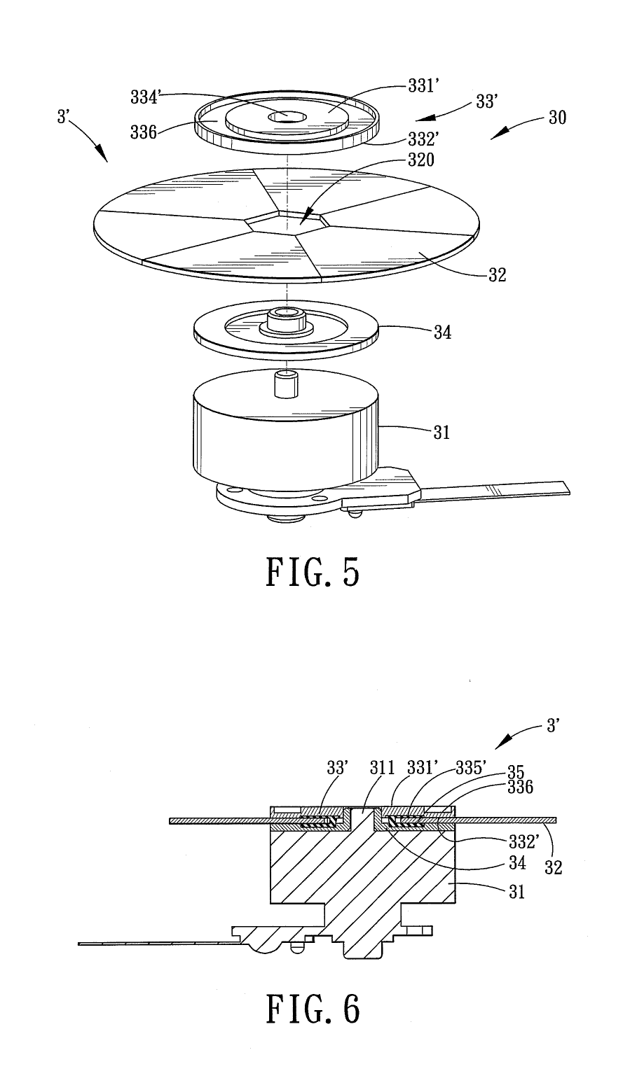

Referring to FIGS. 5 and 6, a color wheel 3′ according to a second preferred embodiment of the present invention is shown, which is similar to the color wheel 3 of the first preferred embodiment. However, in this embodiment, the first notch 335′ is an annular groove that is formed in the lower surface 332′ of the first packing ring 33′ and that surrounds the first central hole 334′. Alternatively, the first notch 335′ may include a plurality of angularly spaced-apart grooves that are formed in the lower surface 332′ of the first packing ring 33′ and that surround the first central hole 334′. During assembly, after the second packing ring 34 and the filter plate 32 are adhered to each other, the first notch 335′ is filled with the adhering unit 35, and then, the first packing ring 33′ is adhered to the filter plate 32. Simultaneously, the adhering unit 35 flows through a portion of the central hole 320 of the filter plate 32 to interconnect with the adhering unit 35 between the second packing ring 34 and the filter plate 32.

Further, in this embodiment, the upper surface 331′ of the first packing ring 33′ is formed with an annular groove 336 adjacent to an outer periphery of the first packing ring 33′. When the filter set 30 and the motor 31 are interconnected, a counterweight unit is placed in the annular groove 336 to balance the color wheel 3′.

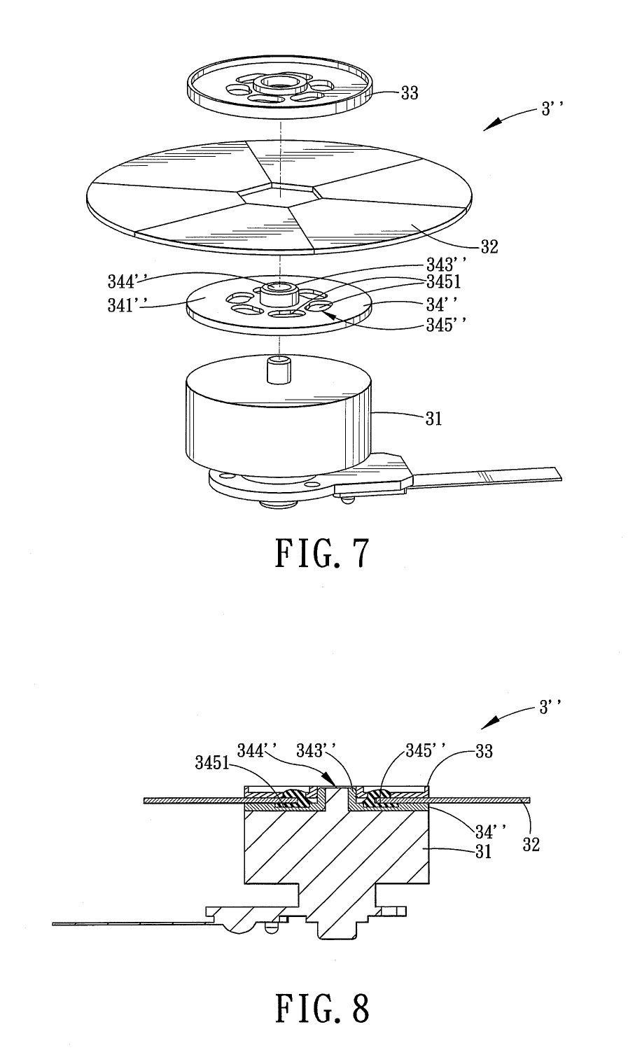

Referring to FIGS. 7 and 8, a color wheel 3″ according to a third preferred embodiment of the present invention is shown, which is similar to the color wheel 3 in the first preferred embodiment. However, in this embodiment, the second notch 345″ includes a plurality of angularly spaced-apart grooves 3451 that are formed in the upper surface 341″ of the second packing ring 34″ and that surround the second central hole 344″. The interconnection of the first and second packing rings 33, 34″ with the filter plate 32 is similar to that described in the first preferred embodiment, so that a detailed description of the same is omitted herewith.

From the aforementioned description, it is apparent that the filter plate 32 and the first and second packing rings 33, 34 are assembled firstly to form the filter set 30, and the filter set 30 is then adhered to the motor 31. Hence, the adhering unit 35 used for interconnecting the first and second packing rings 33, 34 and the filter plate 32 can be an adhesive which has a high heat-resistance, so that the first and second packing rings 33, 34 and the filter plate 32 can be baked at approximately 200° C. Afterwards, the filter set 30 is connected to the motor 31. Not only can the adhering unit 35 be prevented from being carbonized and the filter plate 32 from being scattering as described above, but also, the assembly time of the filter set 30 and the motor 31 can be minimized. In addition, if there is an error in the assembly of the filter set 30, only the filter set 30 is wrote off, and the motor 31 remains unaffected. Meanwhile, the motor 11 in the conventional color wheel 1 becomes useless when there is error in the assembly of the filter set 12 so that the entire color wheel 1 is rendered unusable. Hence, the defect rate of the motor 31 of the present invention is low.

Moreover, since the first and second packing rings 33, 34 are provided within the first and second notches 335, 345, respectively, to receive the adhesive, and the first and second notches 335, 345 is communicated through the central hole 320 in the filter plate 32, the filter plate 32 can be clamped securely between the first and second packing rings 33, 34, so that a scattering phenomenon of the filter plate 32 is prevented, and drilling of holes in the color filter plate 32 is not necessary.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

We claim:

1. A filter set comprising:
a filter plate having a central axis, a first surface, and a second surface opposite to said first surface;
a first packing ring disposed concentrically on said first surface of said filter plate, said first packing ring having a lower surface facing said filter plate and a first notch formed thereon;
a second packing ring disposed concentrically on said second surface of said filter plate, said second packing ring having an upper surface facing said filter plate, said upper surface having a second notch formed thereon; and
an adhering unit provided in said first and second notches for fixing said first and second packing rings respectively to said first and second surfaces of said filter plate.

2. The filter set of claim 1, wherein said filter plate further has an inner peripheral portion defining a central hole, said central hole partially covering said first and second notches, said central hole and said first and second notches being in spatial communication with each other, and said adhering unit being further provided in a portion of said central hole.

3. The filter set of claim 2, wherein said adhering unit includes a first portion, a second portion, and a third portion, said first, second, and third portions are interconnected, and said first portion is disposed in said first notch, said second portion is disposed in said second notch, and said third portion is disposed in said central hole.

4. The filter set of claim 3, wherein said first, second and third portions of said adhering unit are interconnected with a cross section of substantially C-shaped.

5. The filter set of claim 1, wherein said filter plate includes a plurality of truncated sector-shaped filter plates that are interconnected and form a disk-like configuration.

6. The filter set of claim 1, wherein said adhering unit is silica gel.

7. The filter set of claim 1, wherein said first packing ring is circular, and has a first central hole, and said first notch comprises a plurality of through holes that extend through said first packing ring and that are angularly spaced-apart from each other and surround said first central hole.

8. The filter set of claim 1, wherein said first packing ring is circular, and has a first central hole, and said first notch is an annular groove that is formed on said lower surface of said first packing ring and that surrounds said first central hole.

9. The filter set of claim 1, wherein said first packing ring is circular, and has a first central hole, and said first notch comprises a plurality of grooves that are formed on said lower surface of said first packing ring and that are angularly spaced-apart from each other and surround said first central hole.

10. The filter set of claim 1, wherein said second packing ring is circular, and has a second central hole, and said second notch is an annular groove that is formed on said upper surface of said second packing ring and that surrounds said second central hole.

11. The filter set of claim 1, wherein said second packing ring is circular, and has a second central hole, and said second notch comprises a plurality of grooves that are formed on said upper surface of said second packing ring and that are angularly spaced-apart from each other and surround said second central hole.

12. The filter set of claim 1, wherein said filter plate has a central hole, said first packing ring has a first central hole, and said second packing ring has a second hub that defines a second central hole thereof, said second hub extends through said central hole of said filter plate and said first central hole of said first packing ring.

13. A color wheel, comprising:
a motor having a rotary shaft; and
a filter set sleeved on said rotary shaft, said filter set including:
a filter plate having a central axis, an first surface, and a second surface opposite to said first surface,
a first packing ring disposed concentrically on said first surface of said filter plate, said first packing ring having a lower surface facing said filter plate and a first notch formed thereon,
a second packing ring disposed concentrically on said second surface of said filter plate, said second packing ring having an upper surface facing said filter plate, said upper surface having a second notch formed thereon; and
an adhering unit provided in said first and second notches for fixing said first and second packing rings respectively to said first and second surfaces of said filter plate.

14. The color wheel of claim 13, wherein said filter plate further has an inner peripheral portion defining a central hole, said central hole partially covering said first and second notches, said central hole and said first and second notches being in spatial communication with each other, and said adhering unit being further provided in a portion of said central hole.

15. The color wheel of claim 14, wherein said adhering unit includes a first portion, a second portion, and a third portion, said first, second, and third portions are interconnected, and said first portion is disposed in said first notch, said second portion is disposed in said second notch, and said third portion is disposed in said central hole.

16. The color wheel of claim 15, wherein said first, second and third portions of said adhering unit are interconnected with a cross section of substantially C-shaped.

17. The color wheel of claim 13, wherein said filter plate includes a plurality of truncated sector-shaped filter plates that are interconnected and form a disk-like configuration.

18. The color wheel of claim 13, wherein said adhering unit is silica gel.

19. The color wheel of claim 13, wherein said first packing ring is circular, and has a first central hole, and said first notch comprises a plurality of through holes that extend through said first packing ring and that are angularly spaced-apart from each other and surround said first central hole.

20. The color wheel of claim 13, wherein said first packing ring is circular, and has a first central hole, and said first notch is an annular groove that is formed on said lower surface of said first packing ring and that surrounds said first central hole.

21. The color wheel of claim 13, wherein said first packing ring is circular, and has a first central hole, and said first notch comprises a plurality of grooves that are formed on said lower surface of said first packing and that are angularly spaced-apart from each other and surround said first central hole.

22. The color wheel of claim 13, wherein said second packing ring is circular, and has a second central hole, and said second notch is an annular groove that is formed on said upper surface of said second packing ring and that surrounds said second central hole.

23. The color wheel of claim 13, wherein said second packing ring is circular, and has a second central hole, and said second notch comprises a plurality of grooves that are formed on said upper surface of said second packing and that are angularly spaced-apart from each other and surround said second central hole.

24. The color wheel of claim 13, wherein said filter plate has a central hole, said first packing has a first central hole, and said second packing ring has a hub that defines a second central hole thereof, said hub extends through said central hole of said filter plate and said first central hole of said first packing ring.

25. The color wheel of claim 13, wherein said second packing ring has a second central hole with a diameter a little smaller than an outer diameter of said rotary shaft.

26. The color wheel of claim 13, wherein said second packing ring has a second central hole provided with an internal thread, and said rotary shaft of said motor is provided with an external thread thereon for engaging said internal thread of said second central hole.

27. The color wheel of claim 13, further comprising an adhesive layer, wherein said second packing ring having has a second central hole, and said adhesive layer is disposed between said rotary shaft and said second central hole.
